(19) United States
(12) Patent Application Publication
(10) Pub. No.: US 2012/0283085 A1
(43) Pub. Date: Nov. 8, 2012

(54) CENTRIFUGAL APPARATUS FOR BIOCHEMICAL PROCESSES COMPRISING A GAS CHANNELING SYSTEM

(75) Inventor: Niccolo Di Pietro, Lammari (IT)

(73) Assignees: SMART HOSPITAL S.R.L., San Martino in Freddana (IT); GENEDIA S.R.L., Lammari (IT)

(21) Appl. No.: 13/510,957

(22) PCT Filed: Nov. 19, 2010
(86) PCT No.: PCT/IB2010/002988

§ 371 Date: Jul. 16, 2012

(30) Foreign Application Priority Data
Nov. 19, 2009 (IT) PI2009A000146

(51) Int. Cl. B04B 5/04; B01D 43/00

(52) U.S. Cl. 494/26; 494/37

(57) ABSTRACT

An apparatus for performing a process having a step of centrifugation of a material contained in at least one test tube and a step of supplying a gas into the test tube. The apparatus has a centrifugation device provided with a rotor that is rotatably arranged about a central rotation axis, where at least one process housing is defined for at least one test tube, wherein at least one process housing is arranged at a peripheral position of the rotor with respect to the central rotation axis, a cover and a lock means for locking the rotor to the cover, said lock means comprising an elongated portion that is adapted to firmly engage with said rotor. The apparatus has a gas channeling means with a passageway defined in the lock member, the passageway conveying into the chamber a gas flow coming from an external source, and also a discharge passageway.

### FIELD OF THE INVENTION

The present invention relates to a centrifugal apparatus for biochemical processes, and more precisely it relates to a device for supplying a gas into a test tube when the latter is housed within this device.

In particular, the invention relates to a pneumatic device for feeding a gas and operating a transfer means of a reactor such as the one described in WO2008064783, in order to cause a process agent or a process waste to move.

The apparatus allows treating test tube-shaped diagnostic kits that contain biological material samples from/in which DNA and/or RNA has/have to be extracted/amplified.

### BACKGROUND OF THE INVENTION

A reactor for biochemical processes is known from WO2008064783, which has the shape of a test tube for a centrifugal apparatus. Such reactor allows carrying out processes comprising centrifugation steps as well steps of liquid displacement, such as reagents, solvents, liquid waste, from one chamber to another chamber of the reactor. In particular, a liquid displacement step may be the one of a supernatant liquid produced by a centrifugation. To this purpose, a liquid displacement means is provided which is adapted to pressurize by a gas a reactor chamber from which the liquid has to be withdrawn. Such reactor allows carrying out the whole process without removing the reactor from the centrifugal apparatus, thus reducing the working time and eliminating many disadvantages. A particular application is, as above said, DNA and/or RNA extraction from a biological sample.

Always in WO2008064783 an apparatus is described which comprises a centrifugation device that is equipped with a rotor for housing a plurality of reactors, such as the above-mentioned one, and with an air distributor that has one or more passageways that can be connected to be fed by a compressed air generator and to feed the transfer means of each reactor. The generator may have a stem where one or more channels are defined for feeding air to the distributor passageways; the stem is movably supported above the rotor; it can a straight movement between a working position, where it is inserted within a recess of the distributor and a rest position, where it is extracted from this recess. An actuator means may be provided for actuating the movement of the stem, which may be operated by a control unit that controls the rotor as well.

The reactor and the apparatus are adapted to assist a wide variety of biochemical processes that involve centrifugation steps. However, the generator and the previously described apparatus, in particular the air distributor , involve various problems.

Firstly, it is difficult to ensure a uniform air distribution into the multiple test tubes of the centrifugal apparatus. The latter, since they are free vented to atmosphere, oppose a low resistance to air passage; in particular, when the liquid displacement step is nearly over, the air can flow almost freely through the test tubes, which then contain a reduced amount of liquid.

Secondly, the apparatus described does not allow collecting the gas and makes it difficult to treat the gas that flows out of the reactors, which may contain infectious and/or pathogenic substances.

Thirdly, the control unit of the rotor and of the air generation means, as shown in WO2008064783, does not allow a safe operation of the rotor, which can achieve a speed up to 16000 RPM, and of the movable generation means, which may cause mechanical damages to the apparatus and therefore harm to people who are exposed to the biological material that is dispersed into the environment.

U.S. Pat. No. 6,235,537 discloses an apparatus to wash blood cells in a manner that is compatible with an automated sample preparation systems. The test tube containing the cells, which has to be to be washed, is mounted on a rotatable spindle. The spindle includes central passageways for introducing a wash fluid and air into the test tube, and radial exit passageways at the bottom of the spindle. The test tube is first spun about its vertical axis to centrifuge cells against the inner wall of the test tube; after such centrifugation step, a vacuum is applied to the exit passageways, such that the supernatant liquid can be aspirated out through the exit passageways. Wash fluid is then introduced into the test tube, and aspirated out through the exit passageways, thereby washing the cells. Rotational acceleration and deceleration of the test tube then resuspends the cells in the wash fluid. Since the centrifugation is carried out by rotating the test tube about its own longitudinal axis, the centrifugal forces that are created by means of this rotation are limited by the radius of the test tube, and in any case they are strong enough to settle only the cells that have a high sedimentation speed. Therefore, the apparatus described in U.S. Pat. No. 6,235,537 is not adapted for use in processes where a solid phase suspended in a liquid phase is expected to be substantially quantitatively separated, as in case of DNA and/or RNA separation from a biological sample. In such processes, a strong centrifugal force is indeed required, such as the one that can only be obtained by arranging the centrifugal test tubes at a significant distance from the rotation axis of a centrifugal apparatus, in any case at a distance longer than the radius of a common test tube to be used in a centrifugal apparatus, while maintaining the speed within a field of acceptability. Furthermore, by arranging the test tube about the rotation axis of the centrifugal apparatus, even if the supernatant can be sucked during the rotation, it is not possible to treat more than one test tube at one time.

### SUMMARY OF THE INVENTION

It is therefore a feature of the present invention to provide an apparatus for carrying out a process comprising at least one step of centrifugation of the material that is contained in one or more test tubes, and at least one step of supplying a gas into a compartment of such test tubes for causing the contained liquid to be displaced, which makes it possible to prevent an operator from coming into contact with gas exiting from a test tube offgas during the displacement of the liquid, in particular, when the displacement of the liquid is nearly over.

It is also a feature of the invention to provide such an apparatus for uniformly distributing the gas into a plurality of test tubes, in particular, when the displacement of the liquid is nearly over.

These and other objects are achieved by a centrifugal apparatus for biochemical processes for carrying out a process comprising a step of centrifugation of a material contained in at least one test tube and a step of supplying a gas into the or into each test tube, the apparatus comprising:

a centrifugal device having a rotor that is rotatably arranged about a rotation axis, one or more process housing/s defined within the rotor, the housing/s adapted to house the or each test tube, wherein the one or more process housing/s are arranged at a peripheral portion of the rotor with respect to a central rotation axis;

a cover that defines together with the rotor the housings such that the cover blocks the or each test tube within the process housings;

a gas channeling system comprising an inlet passageway defined through the cover, the inlet passageway adapted to convey into the housings a flow of the gas coming from a source that is arranged outside of the cover, wherein a main feature of such apparatus is that the gas channeling system (2,3,4) comprises furthermore a discharge passageway where a portion of the discharge passageway is defined through the cover, whereas the portion of discharge passageway is arranged at a peripheral portion of the rotor with respect to the rotation axis of the rotor, and also that the discharge passageway is adapted to convey outside of the cover a discharge gas coming from the chamber due to a conveying of the gas into the test tube through the conveying means.

Advantageously, the cover comprises a lock member for locking to the rotor, the lock member comprising an elongated portion which extends within the chamber through the cover and an abutting engagement portion for engaging with an outer surface of the cover, the elongated portion adapted to firmly engage with the rotor, the inlet passageway and the discharge passageway extending through the lock means.

In particular, the lock means comprises a lock screw that engages a corresponding thread on the rotor.

The source of compressed air may be a machine such as a fan or a compressor, which is preferably associated with a reserve of compressed air, in particular a backup capacity that is supplied by the actuating machine.

Preferably, a discharge duct is provided for conveying the discharge gas, which comes out of the discharge passageway, to a remote discharge outlet.

Preferably, at the discharge outlet the apparatus provides a treatment unit of the discharge gas which is pneumatically connected with the discharge passageway. In particular, the treatment unit comprises an HEPA filter.

The above-mentioned features allow hindering or preventing an operator from coming into contact with the discharge gas that flows out of the process compartment or compartments of the test tube, which in many applications where centrifugal apparatuses are used, such as in biochemical processes, may contain dangerous substances. Therefore, the invention allows to fully take advantage of such a reactor as the one disclosed in WO2008064783.

Preferably, a peripheral groove is made on an outer surface of the elongated portion of the lock member, the peripheral groove pneumatically connected with the inlet passageway and/or with the discharge passageway. Such peripheral groove serves to make uniform the delivery of the gas in the test tube or in the test tubes.

Advantageously, a centering means is provided for centering the test tube or the test tubes within an own or a respective process housing.

In particular, the test tube or at least one of the test tubes is a reactor such as the one described in WO2008064783, which is adapted to perform a biochemical extraction or purification process of a nucleic acid, typically of DNA, where the biological material is withdrawn only once the process is over.

In particular an exemplary embodiment, the centering means comprise a ring element that provides a respective abutment for the test tube or for the test tubes in position that is peripheral with respect to the rotor axis, the or each abutment engaged by a support portion or by a respective support portion of the test tube or of the test tubes which is subject to a centrifugal force during a condition of movement of the rotor.

The centering means may comprise a plurality of pins and a plurality of respective matching holes, preferably it comprises couples of diametrically opposite pins and holes, in particular it comprises two pins and two respective holes, the pins and the holes provided on the rotor or on the ring element, respectively, or vice-versa.

In a particular embodiment the centering means can comprise an insert ring in use coaxially arranged to the elongated portion of the lock member and arranged between the cover and the rotor, the insert ring having a lower face that provides an abutment for a test tube in order to block the test tube or the test tubes in the process housing or in the respective process housing.

Preferably a securing means is provided for securing the centering means with respect to the cover, said securing means preferably comprising a plurality of screws made along a circumference that has its centre lying on the axis of the cover, the screws engaging respective holes of the centering means. Such fixing and securing means, which is not required in a conventional centrifugal apparatus, is necessary here for preventing the test tube or the test tubes from even slightly moving, which may occur due to the high speed and to possible vibrations, compromising the tightness of the connection of the inlet and discharge openings of test tube or of the test tubes with the channeling means, in particular discharge channeling means.

In particular the channeling means comprises a substantially radial channel defined in the insert ring, the substantially radial channel having two ends with respective tight pneumatic connections that are adapted to engage with, respectively:

the inlet passageway and/or the discharge passageway, which is/are defined in the lock member, and con

a input/outlet opening of one of the test tubes, the tight pneumatic connection with the opening of such test tube equipped with the lock.

Preferably, the apparatus comprises a channeling head movably arranged above the cover between a working position, where the head is inserted in a supporting and centering housing provided in the lock member, and a rest position, where the head is raised with respect to the supporting and centering housing or housings.

Advantageously, the lock member has an axial recess that provides a manoeuvre access and a space for a locking device of the rotor with a driving shaft, and a housing for a removable bush in which the supporting and centering housing is defined.

Advantageously, a first and a second pneumatic valves are provided on the channeling head, or at a remote location, the first and the second valves connected to a pressurized gas supplying network, wherein the first pneumatic valve is adapted to operate a pneumatic actuator for moving the channeling head, and the second pneumatic valve adapted to release the pressurized gas.

Preferably, a first channeling means is provided for pressurizing a first test tube chamber or chambers s in order to displace a liquid from the first chamber to a second chamber through a first liquid displacement passageway, and a second channeling means different from the first channeling means for pressurizing the second test tube chamber or chambers for displacing a liquid from the second chamber to a third chamber, the first and the second channeling means equipped with respective valves.

According to another aspect of the invention, a method for carrying out biochemical processes by means of a centrifugal apparatus, the processes comprising a step of centrifugation of a material contained in at least one test tube and a step of supplying a gas into the or each test tube, the method comprising the steps of:

centrifuging the or each test tube by means of a centrifugation device provided in the centrifugal apparatus, wherein the centrifugation device comprises a rotor that is rotatably arranged about a rotation axis, one or more process housing/s being defined within the rotor for housing the or each test tube, wherein one or more process housings are arranged at a peripheral position of the rotor with respect to the central rotation axis; and wherein a cover is provided which defines the housings together with the rotor, such that the cover blocks the or each test tube within the housings;

stopping the centrifugation device without removing the cover;

conveying a flow of the gas into the housings, through a channeling means for conveying the gas, said gas coming from a source that is arranged outside of the cover, the channeling means comprising an inlet passageway defined through the cover,

wherein said step of conveying comprises a step of discharging outside of the cover a discharge gas coming from the chamber due to the step of conveying, the step of discharging carried out through a discharge passageway, wherein a portion of the discharge passageway is defined through the cover, wherein the portion of the discharge passageway is arranged at a peripheral position of the rotor with respect to the rotation axis.

### BRIEF DESCRIPTION OF THE DRAWINGS

The invention will be made clearer with the following description of exemplary embodiments thereof, exemplifying but not limitative, with reference to the attached drawings wherein:

FIG. 1 shows a longitudinal cross section of the apparatus in a working position;

FIG. 2 is an exploded view of the apparatus of FIG. 1 according to an exemplary embodiment of the invention;

FIG. 3 is a further partial exploded view of the apparatus of FIG. 2;

FIG. 4 is a perspective view of the apparatus of FIG. 2, in which the head is at a rest position;

FIGS. 5, 6 and 7 are two detail views of the locking means of the cover and of the rotor of the apparatus of FIG. 2;

FIG. 8 shows more in detail a seal gasket between the cover and the passageways of the locking means of the apparatus of FIG. 2;

FIG. 9 shows the inner chamber of a rotor of an apparatus according to the invention, wherein two test tubes are arranged within respective process housings;

FIGS. 10 and 11 are two perspective views of a cover of an apparatus according to the invention, which is associated with a centering and seal means of the test tubes;

FIG. 12 is a perspective view of an insert ring that is a part of the centering means of FIGS. 9 and 10;

FIG. 13 is a perspective view of a channeling head for conveying the gas into the chamber of an apparatus according to the invention;

FIGS. 14 and 15 are two perspective views of a bush that can be removed from the fixing member of an apparatus according to the invention, which is equipped with a supporting and centering housing of a channeling head;

FIGS. 16 and 17 are two further longitudinal cross sectional views of the apparatus of FIG. 2, in which the paths of the fed and discharged gas are highlighted.

### DESCRIPTION OF A PREFERRED EXEMPLARY EMBODIMENT

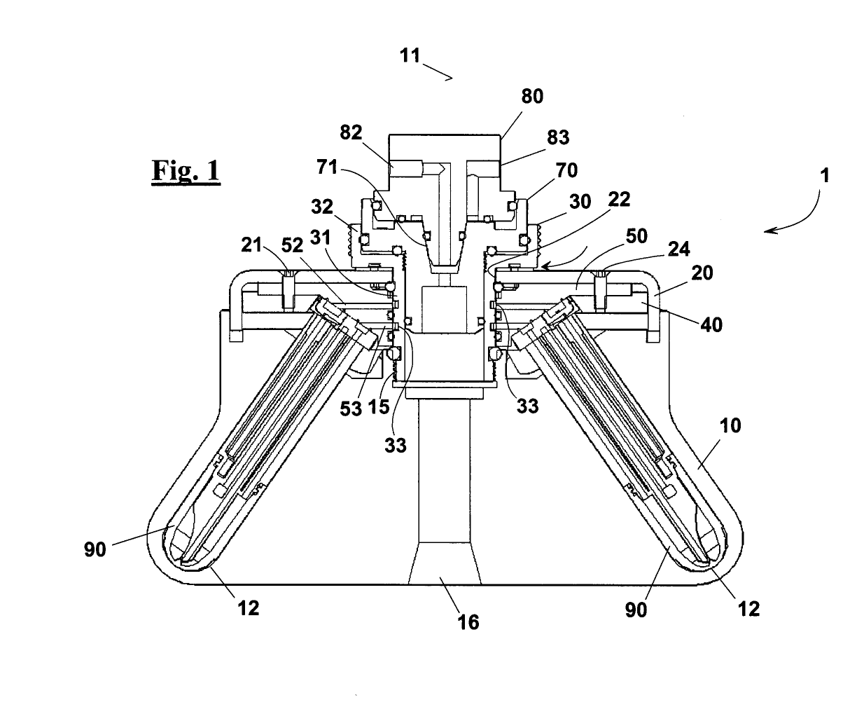

With reference to FIG. 1, it is described an exemplary apparatus 1 of the invention for performing a process that comprises at least one centrifugation step and one gas-supplying step. Apparatus 1 comprises a centrifugation device which is provided with a rotor 10 that has a rotation axis 11, wherein a plurality of chambers or of process housings 12 are defined arranged at a peripheral position of rotor 10, said chamber or process housings adapted to receive a plurality of test tubes 90 in which the process is performed; in a represented exemplary embodiment, ten process housings 12 are provided for the same number of corresponding test tubes 90, which are concentrically arranged at a peripheral position and at a prefixed angle with respect to the central rotation axis 11. Obviously, the invention can be used in a device for centrifuging any kind of test tubes, which has any possible number of peripherally arranged cells.

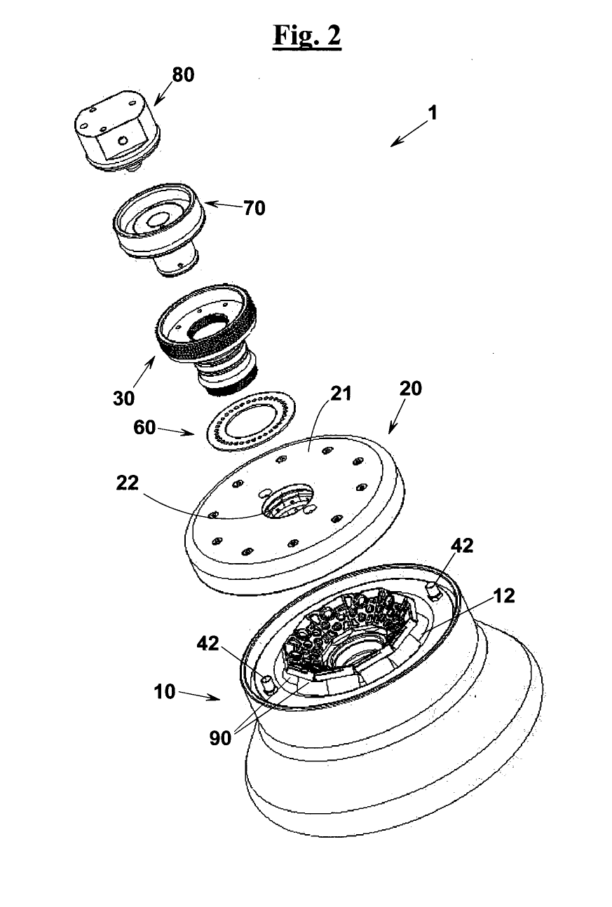

In an exemplary embodiment, still shown in FIGS. 2-4, apparatus 1 may comprise furthermore:

a cover 20 that defines together with the rotor 10 a chamber of the centrifugation device, to enclose the test tubes 90 in the respective process housings 12;

a lock screw 30 for fixing rotor 10 to cover 20; this screw has a stem 31 that protrudes through a hole 22 of cover 20 into the chamber, and has a screw threaded end portion 34, and a head 32 that provides an engagement portion 32′ adapted to abut against an outer surface 21 of cover 20, in such a way to firmly engage with rotor 10 through an external thread 15, and with cover 20.

Within lock screw 30, which is shown in higher detail in FIGS. 5, 6 and 7, two passageways 35 and 36 are defined for conveying a gas flow into the chamber, and a plurality of discharge passageways 37 for conveying a discharge gas out of the chamber, said discharge gas coming from respective test tubes 90.

The gas can be introduced into the test tubes 90 for causing the displacement of a liquid from a chamber into another chamber within test tube 90, by a pressurization means. In particular, test tube 90 may be a reactor such as the one described in WO2008064783 and mentioned above, wherein two inlet openings 92 and 93 are provided which are adapted to receive pressurized air, as well as a discharge opening 94 for expelling the discharge gas (FIG. 9).

Stem 31 of lock screw 30 has two peripheral grooves on its surface, i.e. two ring grooves 33, each connected with one of passageways 35,36.

Lock screw 30 may be a lock screw of a conventional centrifugal apparatus, in particular of a high speed centrifugal apparatus, which has been suitably modified to obtain passageways 35,36 and discharge passageways 37, ring grooves 33 as well as two further ring grooves 28,29 for housing respective O-rings 28′,29′, the latter suitable for providing a fluid tight seal of passageways 35, 36, towards the inside and the outside with respect to the chamber.

Test tube 90, for instance a reactor such as the one described in WO2008064783, has two inlet openings 92,93 for feeding a gas and an outlet or discharge opening 94 for discharging a gas (FIG. 9). In order to ensure a tight connection between such passage openings and the channeling means of the apparatus, including passageways 35,36 and discharge passageways 37, a centering means is provided which prevents the test tubes 90 from significantly moving within the respective process housings 12, during the high speed rotation of rotor 10.

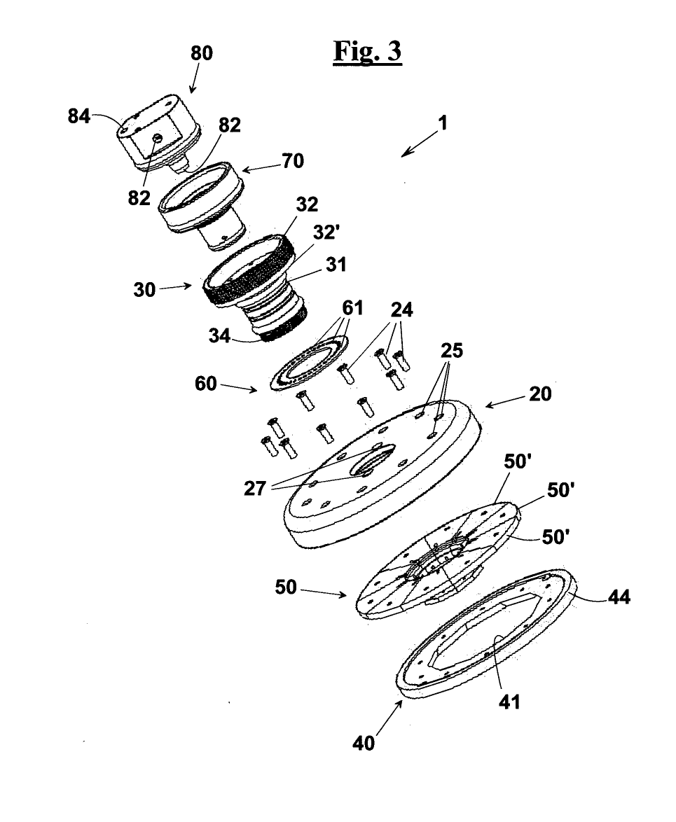

In the illustrated exemplary embodiment, such centering and fixing means comprises a ring 40, as shown in FIG. 3 and more in detail in FIG. 10, which has an outer contour 44 that is suitable for introduction into cover 20, and an inner contour 41 that presents an abutment face to engage a peripheral support portion of a head of test tube 90. The abutment prevents test tube 90 from moving outwardly, when test tube 90 is subjected to centrifugal force due to rotation of rotor 10. In the illustrated exemplary embodiment, the support portions of test tubes 90 are straight portions, therefore inner contour 41 of ring 40 is polygonal, and has a number of sides equal to the number of test tubes 90.

The centering and fixing means comprises furthermore, an insert 50 that is coaxially arranged about lock screw 30, similarly to ring 40, and is arranged between cover 20 and rotor 10. Insert 50 has a lower face that provides an abutment on the upper face of the head of each test tube 90, in order to block test tube 90 in housing 12. To this purpose, in the case of test tube 90 illustrated herein, a plurality of flat facets 56 are provided which define a number of sectors 50′ (FIG. 3) of insert ring 50, which is equal to the maximum number of test tubes 90 that can be housed within rotor 10.

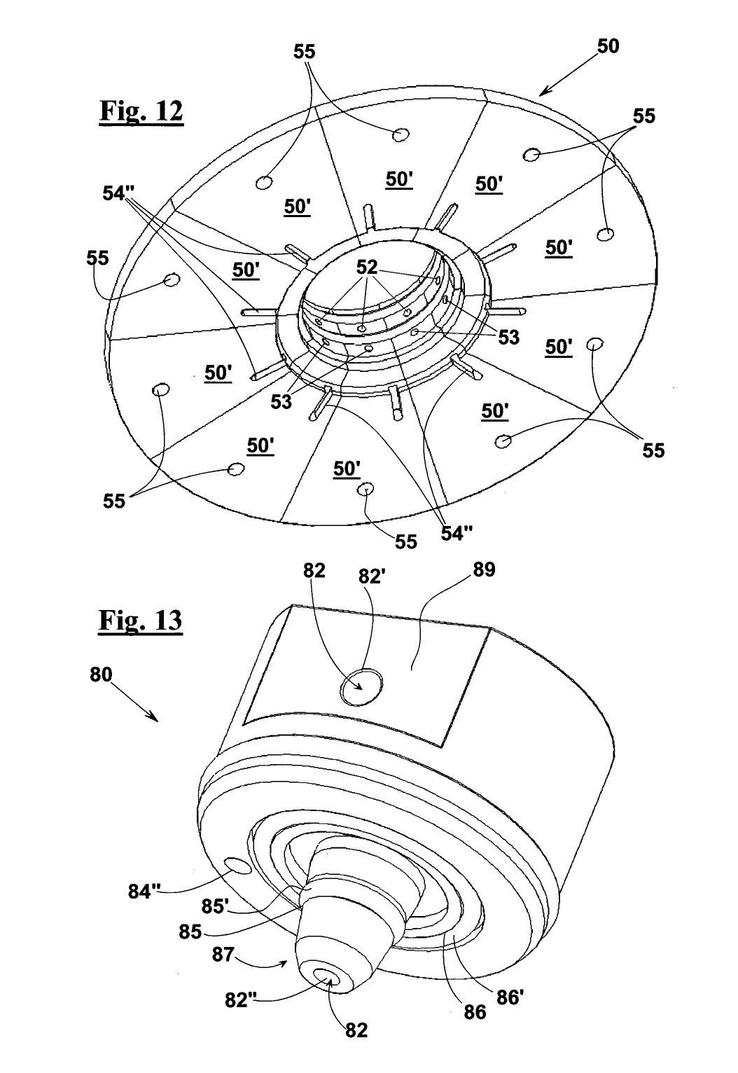

As shown more in detail in FIG. 12, two substantially radial channels 52,53 are defined in each sector 50′ of insert ring 50. Such channels have respective inlet ends 52′,53′ (FIG. 10) that are tightly connected with passageways 35 and 36, respectively, of lock screw 30 (FIG. 5), more in detail, with ring grooves 33 (FIG. 2); channels 52,53 are also provided with respective outlet ends 52″,53″ (FIG. 10) that are tightly connected with inlet openings 92,93 of a respective test tube 90 (FIG. 9).

In each field 50′ a channel 54 is also defined which has a first radial portion and a second portion parallel to central rotation axis 11 of centrifugal apparatus 10, between an inlet end 54′ (FIG. 10), which is gas-tightly connected with discharge passageway 37 of lock screw 30, and an outlet end 54″ (FIG. 12), which is adapted to be gas-tightly connected with a respective discharge opening 94 of the gas of test tube 90. By tightening screw 30, a tight connection is provided between the ends 52′,53′,54″ of channels 51,52,54, and gas inlet openings 92,93 and gas discharge opening 94 of test tube 90, respectively.

To assist the correct location on rotor 10 of the ensemble consisting of cover 20, ring 40 and insert ring 50, two pins 42 are provided which protrude from the surface of rotor 10 (FIG. 9), at diametrically opposite positions, and engage with respective holes 43 made on ring 40 (FIG. 10), such that facets 56 coincide with the heads of test tubes 90.

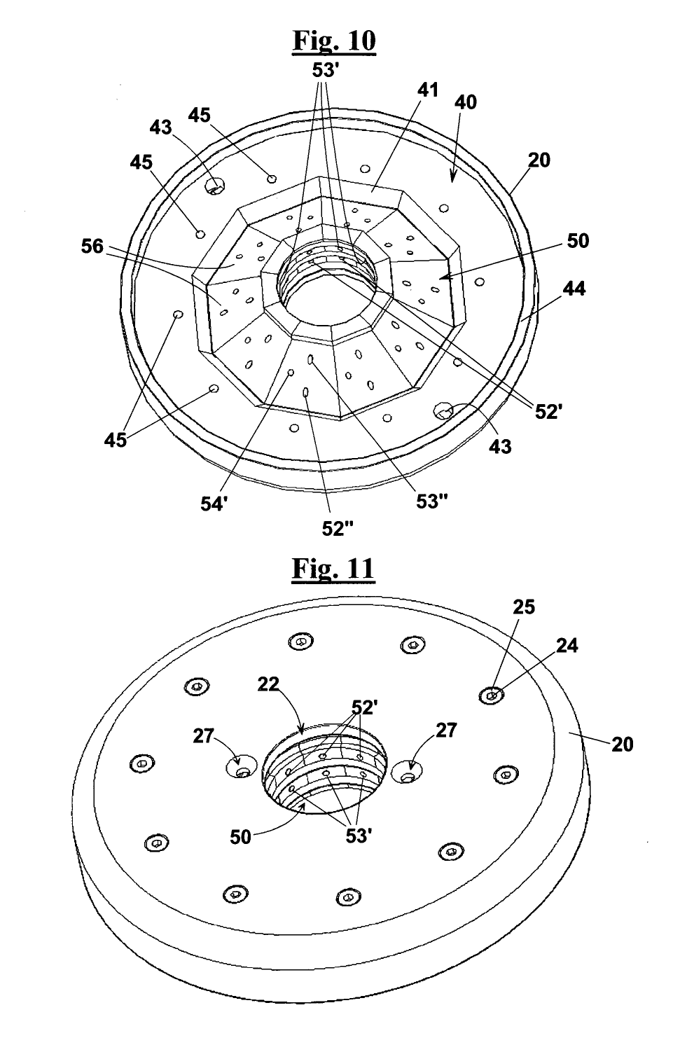

As shown in FIGS. 10 and 11, ring 40 and insert ring 50 are integrally locked to cover 20 by means of a plurality of screws 24 that are arranged along a circumference whose centre lies on the axis of cover 20, such screws engaging respective aligned holes 25, 45, 55 of cover 20, ring 40 and insert 50.

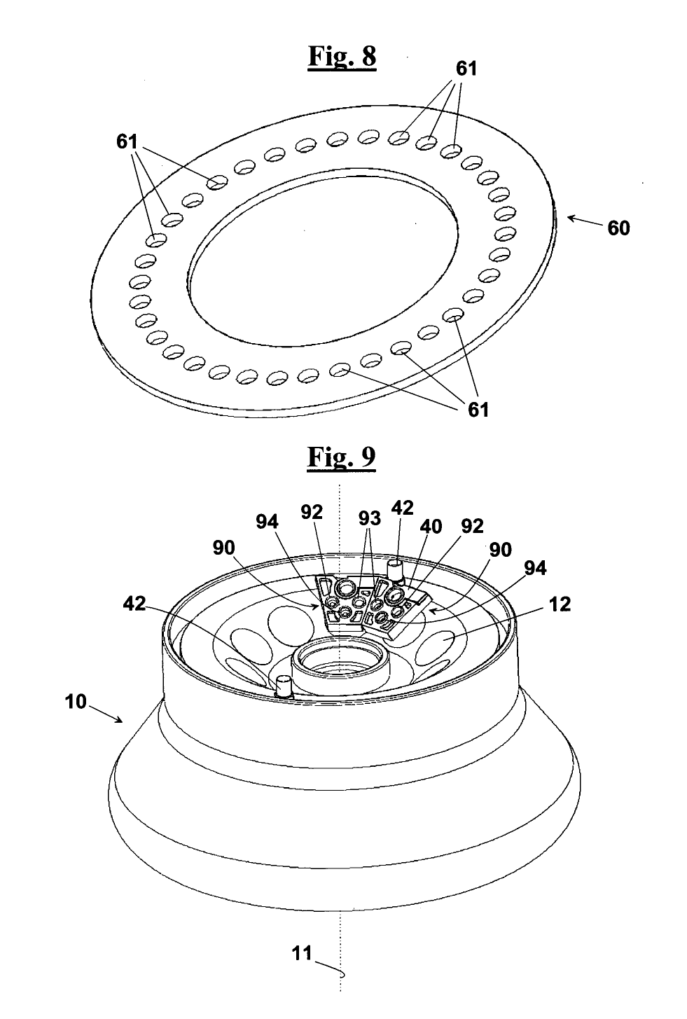

Cover 20 may be a cover of a conventional centrifugal apparatus, which has been modified by making holes 25, for receiving screws 24 therethrough. A further modification of the cover are the diametrically opposite holes 27, which are made proximate to central passage hole 22 for lock screw 30 (FIG. 11). Holes 27 belong to the discharge gas channeling means of rotor 10, and are in gas-tight communication with discharge passageways 37 that are defined in lock screw 30. To provide such gas-tight communication a gasket 60 is used, as shown in FIG. 8, which has a plurality of holes 61 made on a diameter that is substantially equal to the mutual distance of holes 27, in order to assist mounting the seal without caring of the rotation of seal 60 about its own axis, i.e. about rotor axis 11.

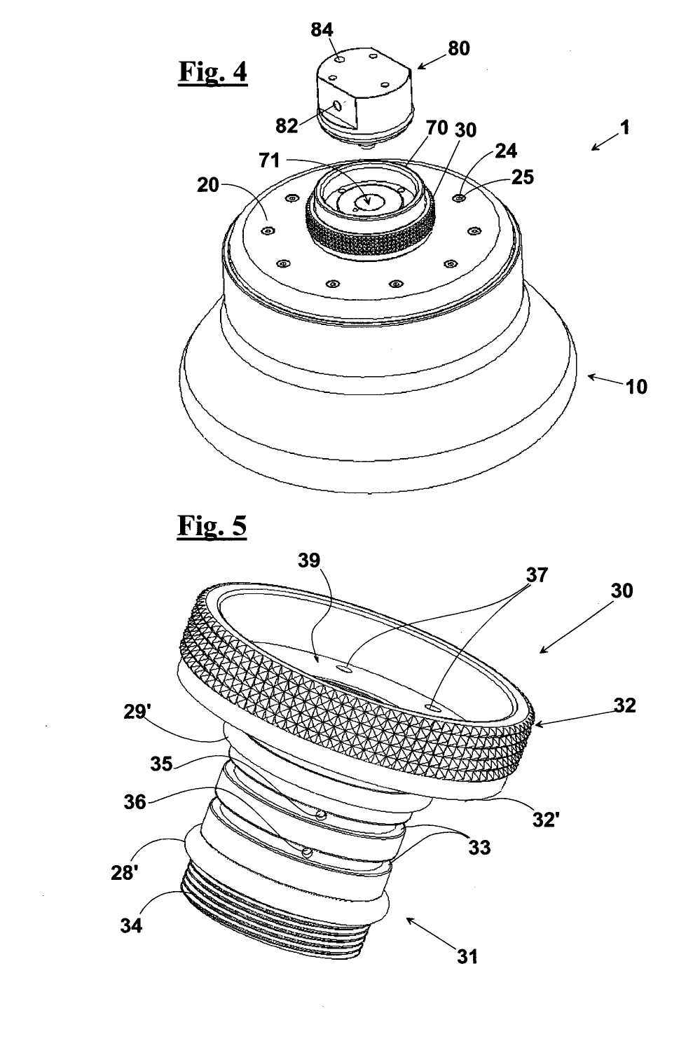

As shown more in detail in FIGS. 4 and 13, apparatus 1 comprises also a channeling head 80 that is supported above cover 20, in a way not shown, and that is movably arranged between a working position (FIG. 2), in which head 80 is inserted within a supporting and centering housing 71, and a rest position, in which head 80 is raised with respect to the supporting and centering housing or housings 71. Two channels 82 and 83 are defined within head 80, which have respective access openings 82′ and 83′ made on side flat portions 89 of the upper portion of head 80, and respective exit openings 82″ and 83″. Channels 82 and 83 comprise each a radial portion and a longitudinal, which are arranged along the axis 11′ of head 80. In particular, the longitudinal portion of channel 82 is co-axial to head 80, and exit opening 82″ is made on top of a substantially frusto-conical portion 87 of head 80, and is adapted to engage with a centering housing 71 (FIG. 4). A groove 85 is made on portion 87 for housing an 0-ring 85′ that is adapted to ensure a tight connection between channel 82 and passageway 35 of lock screw 30 (FIG. 5), when the head is at its working position. Exit opening 83″ of channel 83 is arranged between groove 85 and a further groove 86 that houses a further O-ring 86′, for ensuring a tight connection between channel 83 and passageway 36 of lock screw 30 (FIG. 5), when the head is at its working position.

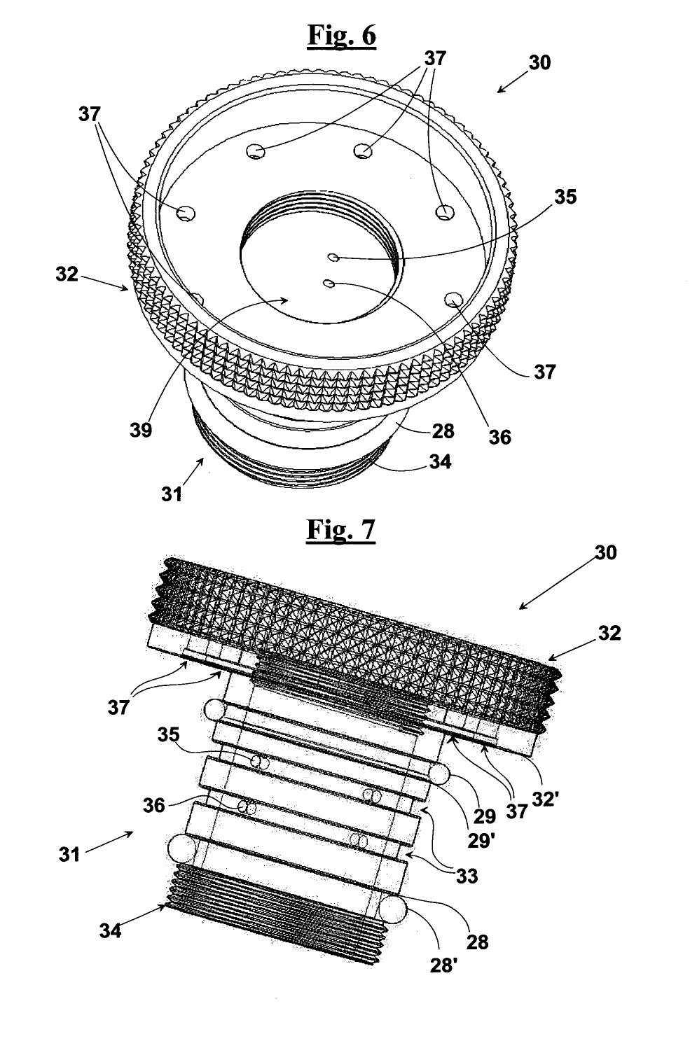

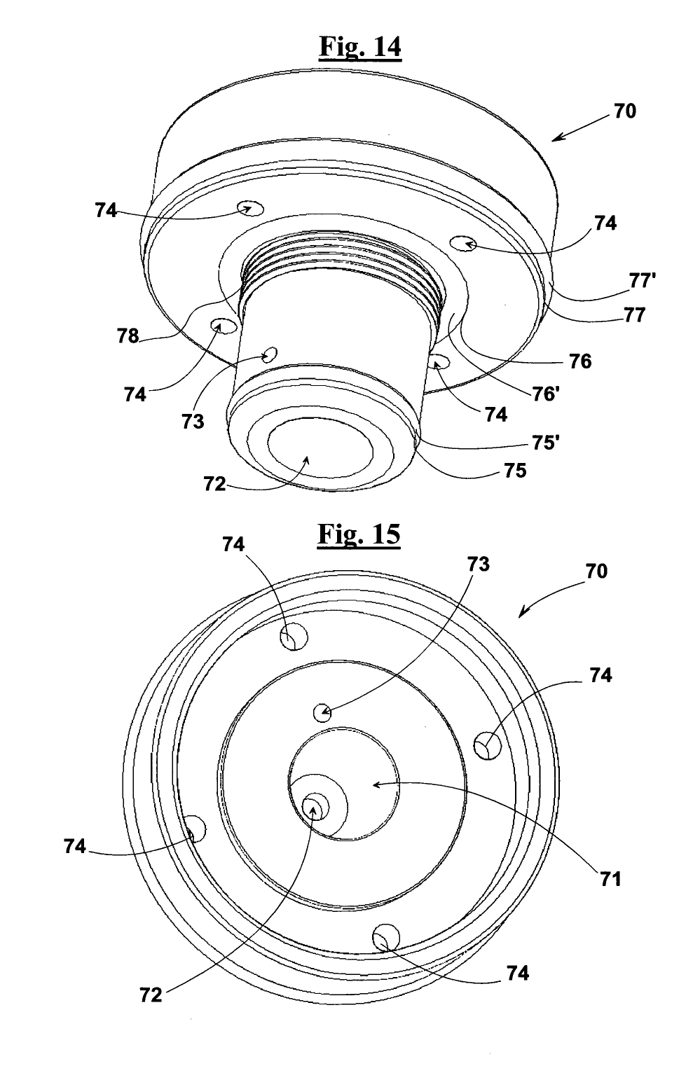

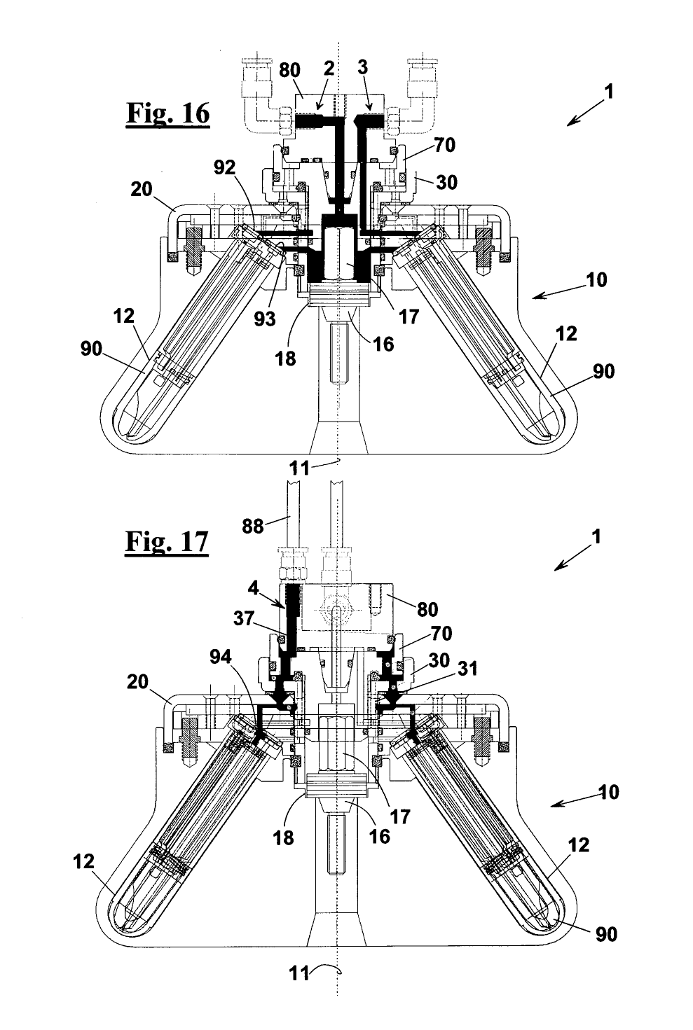

Screw 30 has an axial recess 39 (FIGS. 5 and 6) that provides an access and a manoeuvring space to a nut 17 (FIGS. 16 and 17) which cooperates with an anti-unscrewing device 18 to make it possible to firmly fasten rotor 10 to a drive shaft 16, said anti-unscrewing device consisting of blades having opposite concavities. Moreover, axial recess 39 provides a housing for a removable bush 70, shown more in detail in FIGS. 14 and 15, within which it is defined a supporting and centering housing, as well as connection channels 72, 73 and 74, which are pneumatically connected with channels 82,83 and 84, respectively, of head 80 (FIGS. 2 and 8) and which are also connected with passageways 35,36 and with discharge passageway 37 of lock screw 30 (FIG. 5). Further 0-rings 75′,76′,77′ housed within respective grooves 75,76,77 made on the surface of bush 70 are provided to ensure a tight connection between the respective connection channels of bush 70 and the respective passageways and discharge passageways of lock screw 30. Bush 70 is provided with a thread 78, and is fixed within axial recess 39 of screw 30 by a screwed union.

The cross sectional view of FIG. 16 shows in black the flow path 2,3 of the gas coming from the source, not shown, up to inlet openings 92, 93 of test tubes 90. Both flow paths have an axial portion, which runs through head 80, bush 70 and lock screw 30, as described above.

In particular, the channeling means that convey the gas to opening 93 comprises two ring chambers that are defined between nut 17 and the wall of axial recess 39 of screw 30, as well as a space between nut 17 and an axial recess 79 of bush 70, which is provided for housing nut 17.

Similarly, in the cross sectional view of FIG. 17 the discharge gas conveying means 4 are shown comprising respective discharge openings 94 of test tubes 90 that lead to a discharge duct 88 for conveying the discharge gas to a remote discharge device, not shown, or to a treatment and decontamination unit, not shown, which comprises, for instance, a HEPA filter.

By the above described apparatus, or by a similar apparatus which uses the same principles, it is possible to perform such biochemical processes as the DNA and/or RNA extraction from a biological sample, as well as any other process that comprises a step of centrifugation of a material contained within test tubes 90 and a step of supplying a gas.

More precisely, it is possible to centrifuge the or each test tube by a centrifugation device that is provided in the centrifugal apparatus 1, by rotor 10, which is rotatably arranged about rotation axis 11.

Once the centrifugation has been stopped, and without removing cover 20, it is possible to convey into housings 12, through gas channeling means 2,3,4 a gas flow coming from a source arranged outside of cover 20, through inlet passageway 35 defined within cover 20.

Therefore, according to the invention, the step of conveying comprises discharging outside of cover 20 a discharge gas that comes from the chamber as a consequence of the step of conveying. Such step of discharging is carried out through a discharge passageway 37, wherein a portion of discharge passageway 37 is defined within cover 20 and is arranged at a peripheral position of rotor 10 with respect to rotation axis 11. Such solution allows contemporaneously discharging the discharge gas from all test tubes with no risk of sending the gas into the environment.

The foregoing description of an embodiment will so fully reveal the invention according to the conceptual point of view, so that others, by applying current knowledge, will be able to modify and/or adapt for various applications such embodiment without further research and without parting from the invention, and it is therefore to be understood that such adaptations and modifications will have to be considered as equivalent to the embodiment. The means and the materials to provide the different functions described herein could have a different nature without, for this reason, departing from the field of the invention. It is to be understood that the phraseology or terminology employed herein is for the purpose of description and not of limitation.

1. A centrifugal apparatus (1) for biochemical processes for carrying out a process, which comprises a step of centrifugation of a material contained in at least one test tube (90) and a step of supplying a gas into said or into each test tube (90), said apparatus (1) comprising:
a centrifugal device having a rotor (10) that is rotatably arranged about a rotation axis (1), one or more process housing/s (12) defined within said rotor (10), said housing/s adapted to house said or each test tube (90), wherein said one or more process housing/s (12) are arranged at a peripheral portion of said rotor (10) with respect to said central rotation axis (11);
a cover (20) that defines together with said rotor (10) said housings (12) such that said cover (20) blocks said or each test tube (90) within said process housings (12);
a gas channeling system (2,3,4) comprising an inlet passageway (35) defined through the cover (20), said inlet passageway (35) adapted to convey into said housings a flow of said gas coming from a source that is arranged outside of the cover (20), characterised in that said gas channeling system (2,3,4) comprises furthermore, a discharge passageway (37) wherein a portion of said discharge passageway (37) is defined through said cover (20), wherein said portion of discharge passageway (37) is arranged at a peripheral portion of said rotor (10) with respect to said rotation axis (11);
and in that said discharge passageway (37) is adapted to convey outside of said cover (20) a discharge gas coming from said chamber due to conveying of said gas into said test tube through said conveying means (2,3,4).

2. An apparatus (1) according to claim 1, wherein said cover (20) comprises a lock member (30) for locking said rotor (10) to said cover (20), said lock member (30) comprising an elongated portion (31) that extends within said chamber through said cover (20), said elongated portion adapted to engage stably with said rotor (10), said inlet passageway (35) and said discharge passageway (37) crossing said lock member.

3. An apparatus (1) according to claim 2, wherein said lock member comprises a lock screw (30) that engages a corresponding thread (15) on said rotor (10).

4. An apparatus (1) according to claim 1, wherein a discharge duct is provided (88) for conveying said discharge gas to a remote discharge outlet or to a treatment unit.

5. An apparatus (1) according to claim 1, wherein a peripheral groove (33) is made on an outer surface of said elongated portion (31), said peripheral groove pneumatically connected with said inlet passageway (35) and/or with said discharge passageway (37).

6. An apparatus (1) according to claim 1, wherein a centering means is provided (40,50) for centering said test tube or said test tubes (90) within a respective process housing (12).

7. An apparatus (1) according to claim 6, wherein said centering means comprises a ring element (40) that makes up a respective abutment (41) for said test tube/s (90) in a position that is peripheral with respect to the axis (11) of said rotor (10), said or each abutment (41) adapted to be engaged by a support portion or a respective support portion of said test tube/s (90) which is subject to a centrifugal force during rotation of said rotor (10).

8. An apparatus (1) according to claim 7, comprising furthermore a ring insert (50) that is adapted to be coaxially arranged to said elongated portion (31) of said lock member (30), and to be arranged between said cover (20) and said rotor (10), said ring insert (50) having a lower face that is adapted to provide an abutment (41) for said test tube or said test tubes (90) in order to block said test tube or said test tubes (90) in said housing (12).

9. An apparatus (1) according to claim 5, wherein said gas channeling system comprises a substantially radial channel (52,53) defined in said ring insert, said substantially radial channel having two ends (52′,52″,53′,53″) with respective tight pneumatic connections that are adapted to engage respectively with:
said inlet passageway (35) and/or said discharge passageway (37), which is/are defined in said lock member (30);
an inlet/discharge opening (92,93,94) of one of said test tubes (90);
such that the pneumatic connection with said opening of said test tube (90) is provided by said locking.

10. An apparatus (1) according to claim 1, comprising a channeling head (80) that is movably arranged above said cover (20) between a working position in which said head (80) is inserted into a supporting and centering housing (71) of said lock member (30) and a rest position, where said head (80) is raised with respect to said supporting and centering housing or housings (71).

11. An apparatus (1) according to claim 2, wherein said lock member (30) has an axial recess (39) that provides a manoeuvre access and space for a locking device of said rotor (10) with a driving shaft (16), and a housing for a removable bush (70) in which said supporting and centering housing (71) is defined.

12. An apparatus (1) according to claim 1, wherein a first and a second pneumatic valves are provided on said channeling head, or at a remote location, said first and said second valves connected to a pressurized gas supplying network, wherein said first pneumatic valve is adapted to operate a pneumatic actuator for moving said channeling head, and said second pneumatic valve is adapted to release said pressurized gas.

13. A method for carrying out biochemical processes by means of a centrifugal apparatus (1), said processes comprising a step of centrifugation of a material contained in at least one test tube (90) and a step of supplying a gas into said or in each test tube (90), said method comprising:
centrifuging said or each test tube by means of a centrifugation device provided in said centrifugal apparatus (1), wherein said centrifugation device comprises a rotor (10) that is rotatably arranged about a rotation axis (11), one or more process housing/s (12) being defined within said rotor (10) for housing said or each test tube (90), wherein said one or more process housing/s (12) are arranged at a peripheral position of said rotor (10) with respect to said central rotation axis (11); and wherein a cover (20) is provided that defines together with said rotor (10) said housings (12), such that said cover (20) blocks said or each test tube (90) within said housings (12);
stopping said centrifugation device without removing said cover (20);
conveying a flow of said gas into said housings (12) through a conveying means (2,3,4) for conveying said gas, said gas coming from a source that is arranged outside of the cover (20), said channeling means (2,3,4) comprising an inlet passageway (35) defined through said cover (20), characterised in that said step of conveying comprises a step of discharging outside of said cover (20) a discharge gas coming from said chamber due to said step of conveying, said step of discharging carried out through a discharge passageway (37) wherein a portion of said discharge passageway (37) is defined through said cover (20), wherein said portion of said discharge passageway (37) is arranged at a peripheral position of said rotor (10) with respect to said rotation axis (11).
